(19) United States
(12) Patent Application Publication
(10) Pub. No.: US 2025/0208624 A1
(43) Pub. Date: Jun. 26, 2025

(54) METHOD AND SYSTEM FOR CONTROLLING A MOVEMENT OF TRANSPORT UNITS

(71) Applicant: Siemens Logistics GmbH, Nürnberg (DE)

(72) Inventors: Jochen Ebigt, Duisburg (DE); Lars Jahn, Möhrendorf (DE); Matthias Klein, Hanau (DE); Bengt Mueck, Nürnberg (DE)

(21) Appl. No.: 18/851,470

(22) PCT Filed: Mar. 24, 2023
(86) PCT No.: PCT/EP2023/057607

§ 371 Date: Sep. 26, 2024

(30) Foreign Application Priority Data
Apr. 4, 2022 (EP) 22166530.0

(51) Int. Cl. G05D 1/249; G05D 1/667; G05D 1/69; G05D 105/20; G05D 107/80; G05D 109/10; G05D 111/10; G06T 7/70

(52) U.S. Cl. CPC G05D 1/249; G05D 1/667; G05D 1/69; G06T 7/70; G05D 2105/20; G05D 2107/85; G05D 2109/10; G05D 2111/17

(57) ABSTRACT

A method and a system for controlling a movement of transport units inside a control area of an installation includes initially capturing and identifying a transport unit at a known position. The transport unit is subsequently moved and the positions of the transport units within the control area are continuously captured over time using a position capture device and are transmitted to a background system. On the basis of the initial position, the background system assigns the captured positions of the transport units to the captured identity of the relevant transport unit and maps the positions of the transport units, in particular of the identified transport unit, in the control area. This allows the movement to be controlled without the need for a separate marking of the transport unit for the position capture device.

The present invention relates to a method and system for controlling a movement of transport units.

The present invention relates in particular to the technical field of transporting transport units within an airport for items of luggage and general cargo, in particular containers such as unit load devices (ULDs), trays ((luggage) bins) and tray racks. However, the inventive method and system is also suitable for wide application in other areas of logistics with other transport units. A transport unit or logistical unit is an individually assembled collection of loading units such as general cargo (in the airport sector in particular items of luggage and cargo goods) for the purpose of transportation and/or temporary storage, typically a pallet, a container or a transport bin. But even just a single item of general cargo (with or without transport aids such as ULD, pallet, receptacles, etc.) can already form a transport unit.

Many areas of logistics operations such as in airports are handled manually or in a mixed automatic-manual operation using manual conveyance elements such as castor surfaces, ball roller surfaces, slave pallets, etc. to move transport units (loading units, ULDs, larger transported goods, trays, items of luggage, AGVs, etc.). These manual conveyance elements are employed for loading and unloading as well as for internal transportation and for storing and sorting transport units. They are modular, hence highly flexible, and well designed for peak loads, yet the opportunities for computer-aided technical material tracking are limited.

Fitting all transport units with their own RFID tags or similar means does enable tracking to take place, but sensors to capture the RFID tags are required and moreover the transport units have to be captured or checked out each time they enter and leave the installation, since established, cross-airport systems do not exist.

The prior art is the selective capture of transport units and if applicable their loading units using hand-held scanners or control keyboards at node points, in particular when they enter an automatic installation area or when a transport unit is loaded and unloaded. As a result, for example, general cargo that has been loaded into a ULD is associated with this ULD. However, the method is entirely manual, i.e. it is also prone to error, since it requires the operating personnel to make correct inputs.

Only at the moment of capture and in the automatic transport area is the location (scan point) of the transport unit known. If the captured transport unit moves within the installation away from its capture location or out of the automatic area, no further information is available and the position of the transport unit is not mapped in the IT system. Which containers are moved from which entrance to which further point is not mapped digitally. Nor is the position of parked containers captured. Thus the manual area cannot be managed by an IT system, since the unique position of the loading unit is not known. This is problematic, since transport units can get lost or forgotten within the manual area. Finding them again takes extra time and personnel, in particular if as a result ULDs no longer make it to their intended flight. Hence there is a need for improved position tracking, in particular when the transport units are moved manually.

The object of the present invention is hence to provide a method and system for controlling transport units in an installation, which with little equipment outlay enables the positions of manually moved transport units to be mapped and as a result the movement of the transport units to be controlled in an IT system. This object is achieved by the features specified in the independent claims.

The inventive solution relates to a method for controlling a movement of transport units with associated sorting criteria within a control area of an installation using the following method steps. First capture of identity and time stamp of one or more transport units at a known initial position (same or different position for different transport units). The first, initial capture of identity and time stamp takes place in particular in connection with an entry of the corresponding transport unit into the control area. Movement of at least one of the transport units, in particular the identified transport unit. Capture of the positions of the transport units within the control area over time using a position capture means designed to capture positions of transport units without the need for separate marking of the transport units. Continuous transmission of the captured data to a background system. Continuous assignment of the captured positions of the transport units to the captured identity of the transport unit in question by the background system, starting from the initial position. Mapping of the positions and/or changes in position of the transport units, in particular the identified transport unit, in the control area by the background system.

As regards a device, the above-mentioned object is achieved by a system for controlling a movement of transport units with associated sorting criteria in an installation. The system comprises a means for capturing the identity and time stamp of one or more transport units at a known initial position. The system comprises a position capture means designed to capture positions of transport units within the control area over time without the need for separate marking of the transport units. The system comprises a means for transmitting the captured data to a background system, wherein the background system is designed for the continuous assignment of the captured positions of the transport units to the captured identity of the transport unit in question and for mapping the captured positions of the identified transport units. The system is designed for the performance of the inventive method.

An identity of a transport unit should be understood as a unique identifiability of the transport unit in question, such as for example a luggage identification number on a luggage tag, etc., wherein this identity remains unchanged even when the physical properties of the transport unit change (for example due to a slight change in shape, when objects are removed from the transport unit, unintended removal of the luggage tag, etc.). At the simplest, this identity is captured by a luggage tag (in paper form, RFID tag, etc.) being captured/read by an appropriately designed capture means. Using the captured positions, a movement and thus the position of a once identified transport unit can be determined at each capture time. The capture times should be close enough together in time so that the captured positions of a transport unit at two consecutive capture times can be uniquely assigned to this transport unit. Thus faster movements and/or a high density of transport units and/or further objects require more closely meshed capture times. Otherwise, an assignment can be made based on captured physical properties of the transport unit.

The device has, where transferable, the same advantages as those listed with regard to the method presented. The description given hitherto of advantageous embodiments of the invention contains numerous features, some of which are combined with each other in the individual subclaims. However, these features can expediently also be considered individually and combined to form further meaningful combinations. In particular, these features can each be combined individually and in any suitable combination with the inventive method, the inventive functional unit and the inventive sorting system. Thus method features are also to be seen as a property of the corresponding device unit concretely formulated and vice versa.

This can thus result in the following advantages:

The inventive solution is characterized in that the background system can, at each capture time, map the position of each identified transport unit, as well as any (as yet) unidentified transport units, in their capture area. Thus captured and uncaptured transport units can be located. Starting from the known initial position of the first capture, a further position determination is carried out thanks to continuous comparison; the background system creates a movement map of the control area. It is possible continuously to map the changes in position of all transport units together with an associated captured or unknown identity of the transport unit. The knowledge of the positions allows control of the capture area. Starting from the initial first capture, the movement of transport units within the control area is tracked automatically.

The inventive solution enables position control, without further steps having to be taken to capture the identity of the transport unit-the normal operational sequence is not impaired. The moving transport units need not be fitted with their own capture elements (RFID tags, direction-finding sensors, etc.). Manually performed movements can be digitalized. The solution is moreover easily retrofittable, both in indoor installations and in outdoor installations. The only components needed for a retrofit are position capture means and background system.

Advantageous embodiments of the invention emerge from the subclaims.

In accordance with one form of embodiment, the position capture means can comprise a lidar unit (Light Detection And Ranging) and/or a camera system (in particular optical and/or TOF cameras) and/or a light grid and/or an optical sensor (e.g. macro sensor, photoelectric sensor, photoelectric barrier, light grid, light scanner, etc.). All systems that are able to differentiate individual transport units from one another in the capture area are suitable as position capture means, i.e. the captured contrast of the mapping must be sufficient to map individual transport units uniquely. Moreover, it must be possible to assign the position of the captured transport units to the real position in space.

In accordance with one form of embodiment, capture of a shape (2D or 3D) of the identified transport unit(s), as well as any unidentified transport units, can take place within the control area over time (with the same or a different capture rate as for the position capture) using the position capture means or another device designed to capture and thus track a shape (volume or extent) of objects, in particular of transport units. Thus loading and unloading operations can be mapped, but damage to the transport units can also be determined.

In accordance with a further form of embodiment, the background system can detect deviations in the captured shape of the transport units, in particular the identified transport unit, at different capture times and signal them with a message and/or store them. Thus unintentional deviations (e.g. damage) as well as intentional deviations (e.g. confirmation that loading/unloading has taken place) can be mapped to the previous state.

In accordance with a further form of embodiment, loading and/or unloading of a transport unit using one or more loading units within the control area can be monitored by the background system, as can the movement of the transport unit. The initial position of the loading unit is captured and thanks to continuous position monitoring the position of each identified loading unit in the transport unit is also mapped by the background system.

In accordance with a further form of embodiment, for efficient loading operations the loading and/or unloading can be controlled using movement commands. All method steps and features for the method described in respect of the transport unit can also be applied to the loading unit.

In accordance with a further form of embodiment, the background system can check the length of time the identified and/or captured transport units spend in the control area or, if the length of time in multiple control areas is known, in the installation, and can signal with a message if the length of time exceeds a predetermined value (this can vary depending on the task/application). This prevents transport units from being forgotten or staying in the control areas of the installation for too long (perishable goods, medicines, etc.), even if the initial capture was inadvertently not performed.

In accordance with a further form of embodiment, further objects in the control area can be captured using the position capture means or another device designed to capture the further objects, in particular moving objects such as persons, and the captured data can be transmitted to the background system. In this case the background system or the capturing device can be designed to detect and if applicable classify the captured further objects. Moreover, a warning can be issued if the further object is arranged in the immediate vicinity of a transport unit. This allows transport units to be reliably differentiated from operating personnel. Manipulation of the ULD can be captured during the process. Access protections can be set up by prohibiting occupancy for objects (if this is ignored, a warning is issued) and automatic movements of those transport units in the immediate vicinity of the detected object can be restricted.

In accordance with a further form of embodiment, the background system can issue instructions for an intended movement of the identified transport unit, wherein these instructions can be implemented by operating personnel and/or automatically. The background system can preferably detect deviations between the intended and actually captured movement and signal this with a message. The instructions can be determined as a function of the sorting criterion of the identified transport unit and as a function of the arrangement and/or movement commands of the remaining transport units within the control area. This movement command can include specific movement instructions, but can also be a simple instruction such as the final destination—in which case only excessively large distances from the final destination are signaled. The instructions can be executed by operating personnel in manual operation. In installations with automatically movable transport units the corresponding conveyance devices (transport vehicles, e.g. forklifts, AGVs and/or conveyance means, e.g. conveyor belts, etc.) can also be controlled directly. Thus transport orders can be transmitted and a transport vehicle situated near to the transport unit to be moved can execute the instruction. This allows the inclusion and control of the manual processes by the background system. The conveyance device can be comprised by the transport unit.

In accordance with one form of embodiment, the control area can be divided into subareas, and universal or transport-unit-specific occupancy prohibitions can be assigned (i.e. no transport unit may be moved into this subarea) to one or more of the subareas, and/or free and/or occupied subareas can be displayed.

For the movement instructions, occupancy prohibitions and the fill level of the subareas are of course taken into account as well as the captured presence of (moving) objects (transport units or others) in or near the subareas. Moreover, the sorting destinations or intended movements of other transport units can be optimized to one another.

In accordance with one form of embodiment, the installation can have two or more control areas with different requirements for accuracy and/or frequency of capture by the position capture means. The two or more control areas can, but need not, have a different type and/or number and/or sensitivity of the position capture means-depending on the requirements for the type of monitoring. Thus a first control area can be a loading and/or unloading area with high requirements for the accuracy of monitoring, whereas for a second control area as a simple transport area a lower level of accuracy is sufficient. The position tracking of smaller transport units requires a higher level of accuracy than that of larger transport units at the same movement speed.

In accordance with one form of embodiment, the installation can comprise manual conveyance elements, and/or the transport units (2.1) can be moved automatically. The term manual conveyance element includes any transport element/means that is not completely automatic conveyor technology, but requires an operator (castor surfaces, ball roller surfaces, slave pallets, etc. as well as forklifts or other ground conveyors). The inventive solution is however also suitable for position determination on non-manual conveyance elements, e.g. to detect and signal deviations from the intended transport route (e.g. by uncontrolled slipping on conveyance surfaces, blockages, etc.). The automatic movement can be achieved by vehicles (AGV, forklifts, etc.) or by other conveyance means.

In accordance with one form of embodiment, the captured position for a selected identified and/or captured transport unit can be displayed. In this case an additional camera image can be linked to the mapping of the background system or the background system can give position instructions to an operator for easy location.

Forms of embodiment of the invention are for example explained in greater detail below on the basis of the figures, in which:

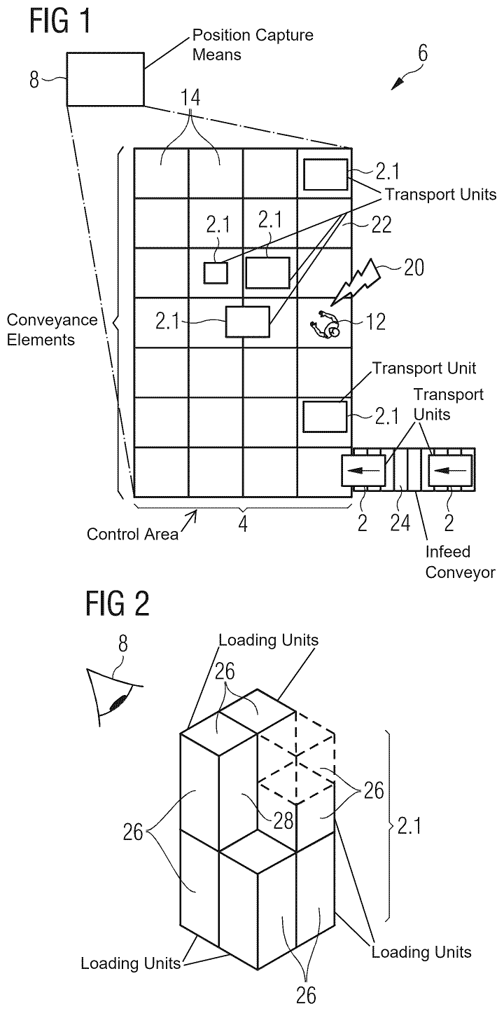

FIG. 1 schematically shows a sorting area for transport units within an airport;

FIG. 2 shows a transport unit;

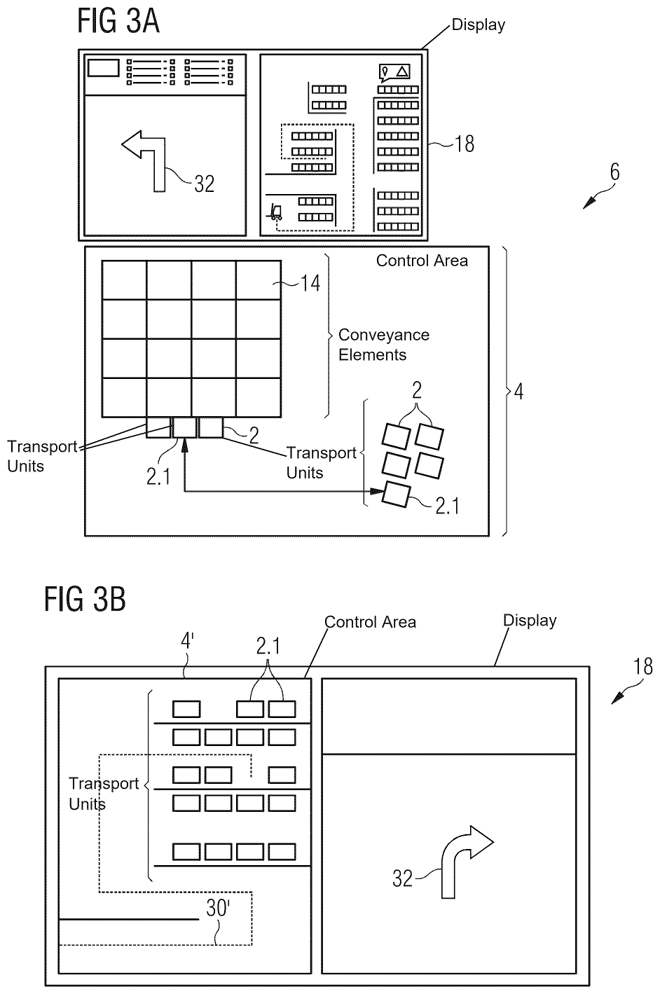

FIGS. 3a, 3b shows transport instructions for an identified transport unit; and

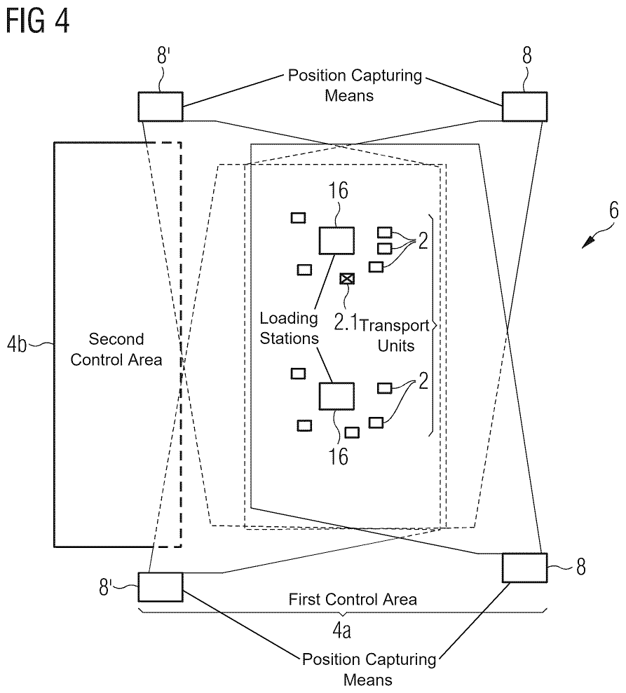

FIG. 4 shows an installation with two control or handling areas.

The exemplary embodiments described in detail below relate to an airport installation 6 with ULD transport units 2. However, the invention is not restricted to airports but can be used for a wide variety of installations 6 and transport units 2 in other logistics areas, e.g. in commissioning or in postal sorting, in particular in the field of parcels and packages.

In accordance with one form of embodiment, FIG. 1 shows a sorting area 4 for ULDs 2 within an airport installation 6. The ULDs 2 are fed to the sorting area 4 on an infeed conveyor 24. The sorting (intermediate) destinations of airport ULDs 2 are determined by the sorting criteria of the ULDs 2 that are determined by the sorting information of their items to be loaded 26 (suitcases, cargo); each ULD 2 is uniquely marked. The movement of the ULDs 2 in the airport installation 6 is controlled manually, manually-assisted or using conveyance means, i.e. with a transport means, depending on the area. The ULDs 2 are both sorted directly and also stored temporarily.

On entry, on transition between the automatic and (semi-) manual areas 24, 4, capture technology (hand-held scanner, capture gate, etc.) is used for the initial capture of a ULD 2 (first capture). The initial capture takes place either always at the same position (capture gate, etc.) or at a variable position (hand-held scanner which supplies a position in addition to the scan data)-the only important thing is that at the initial capture time the position can be determined and thus the sorting criterion of this now identified ULD 2.1 is known. The captured data is transferred to a background system. If the initial capture takes place in connection with the entry of the ULDs 2 into the control area 4, all ULDs 2.1 in the control area 4 are identified. Thus the capture and classification of further objects 12 in the control area 4 is simplified.

In the control area 4 the ULDs 2, 2.1 are moved to their sorting destinations and if applicable are stored temporarily. The sorting area 2 is captured using capture technology 8 at short time intervals, i.e. virtually continuously, and the positions and/or changes in position of the captured ULDs 2, 2.1 are mapped, so that the position and identity of a once identified and located ULD 2.1, which is then moved, can be tracked and thus at any capture time the position of the identified ULD 2.1 and of the remaining objects 2, 12 is known. The background system then maps position and identity of each once identified ULD 2.1, without the capture technology 8 itself having to be able to again read out the sorting criterion or the ULD identity, i.e. for the identification of the identified ULD 2.1. The position is captured after a cycle time has elapsed, if the capture means 8 detects a change in position or in response to a command.

The capture technology 8 captures the position of the ULD 2, 2.1 without the need for separate marking of the ULDs 2.1, 2; it is thus a position capture means 8 and must be able to differentiate and locate the individual ULDs 2, 2.1 within the control area 4 uniquely from one another and from the background. Based on the initial known position, the identity of the ULDs 2.1 is assigned, since changes in position are incremental at a sufficient capture rate, so that the assignment is unique. However, in principle an identification of the ULD 2 can also take place later.

All elements (ULDs 2, load 26, further objects 12) situated in the control area 4 and known to the background system are tracked virtually permanently and their positions are continuously mapped by the background system. The control area 4 comprises at most the capture area of the position capture means 8, for which the required sensitivity and 11 resolution are guaranteed. The control area 4 can be expanded by the addition of further position capture means 8. The control area 4 can also be made smaller.

A unit 8 comprising lidar sensors is in particular suitable as a position capture means 8. However, other systems, e.g. a camera system (time-of-flight camera, ordinary cameras, etc.), light grids or optical sensors-can also be used individually or in combination. However, camera systems work well for position tracking only if the contrast between the ULDs 2 themselves, as well as with the surrounding area, is always sufficient, since only in this way can unique position tracking by the background system be guaranteed.

Lidar units 8 in which a laser creates a point cloud are particularly suitable, since the contrast problem is not relevant and moreover a very good depth resolution can be achieved. Lidar sensors 8 are moreover commercially available for different requirements as regards capture sensitivity. The computational effort is limited even at high scanning rates and there are proven methods for optimizing the measured values (noise suppression, background correction, position correction transformation).

In addition to capturing the position, lidar sensors 8 also permit the capture of the three-dimensional shape of the objects 2, 12 in the control area 4. The shape can also be captured using stereo cameras 8 or other means. However, optical cameras 8 have the disadvantage that personal data is captured. A lidar unit 8 does not detect faces, so no privacy or data protection issues exist. Since lidar units 8 are very well suited for creating a surface model and hence for determining distances between individual objects 2, 2.1, 12, a very accurate mapping of the occupancy situation by the background system is possible. The contrast problem of optical cameras does not exist.

The position capture means 8 captures not only ULDs 2, 2.1 in the capture area 4, but also further objects 12, including persons 12. The background system is designed to detect and if applicable classify the captured further objects, so that a warning can be issued in the event of danger. If a person enters the control area 4, this is detected by the background system and all automatic movement around the person (plus a safety area) can be stopped, by blocking the area of the control area 4 occupied by the person 12 as well as any safety area for automatic ULD movements. Manual movements of the ULD 2 brought about by the person are now captured by the lidar system 8 and are sent to the background system.

Moreover, thanks to the capture system 8 it is possible to monitor whether persons are situated in an area that is used in mixed operation. The advantage of this is that automatic movements in this area containing persons can be prevented.

To prevent a dangerous situation, a warning is issued if a further object 12 is arranged in the immediate vicinity of a ULD 2. The background system or the capturing device 8 is preferably designed to detect and if applicable classify the captured further objects 12.

In accordance with one form of embodiment, the control area 4 is divided into subareas. One or more of the subareas are assigned universal or transport-unit-specific occupancy prohibitions, i.e. a specific identified ULD 2.1 or all ULDs 2 must not be moved into these subareas, e.g. if persons 12 are detected in or near the subareas. Alternatively or additionally, subareas that are occupied by objects 2.1, 2, 12 and/or are free are displayed. The fill level of the control area 4 is thus monitored.

The control area 4 is preferably divided into subareas of a grid, wherein the subareas represent individual spaces, to each of which a ULD 2 can be assigned. The more detailed the grid, the better can the use of the subareas be controlled by the background system.

In the specific case of modular castor surfaces 14 which are formed in an automatic-manual mixed operation from individual conveyance elements 14, a castor conveyance element 14 comprises one or more subareas.

FIG. 2 shows an identified transport unit 2.1 mapped by a lidar unit 8, which comprises individual loading units 26 and is not yet completely packed. The free space 28 can be detected by the lidar unit 8. The operator can then be given the instruction to load the free space 28 with a further loading unit 26 of appropriate size, wherein the determination of the size of the further loading unit 26 can likewise be done using the lidar unit 8.

In accordance with a further form of embodiment, the shape (volume, extent) of transport units within the control area 4 is captured over time at the same or a different capture rate as the capture of the positions, in particular during a loading or unloading operation. The background system detects and signals with a message and/or stores deviations between the initial and subsequently captured shape of a specific transport unit 2.1, 2 at different capture times. Unintended deviations (e.g. damage to the transport unit 2.1, 2, theft of individual loading units 26), as well as intended deviations (e.g. confirmation that loading or 11 unloading has taken place) are detected by the background system and stored, so that it is possible to access them later.

In accordance with a further form of embodiment, the loading and/or unloading of a ULD 2.1 with loading units 26 within the control area as well as the movement of the ULD 2.1 will be monitored by the background system. Instead of the movement of the ULD 2.1, the movement of the loading unit 26 is monitored, wherein the initial capture of the position of the loading unit 26 takes place first and then the position of each identified loading unit is known and can be mapped by the background system thanks to continuous position capture. The loading and unloading can likewise be controlled with instructions relating to the loading units.

FIG. 3a shows a section of a control area 4, wherein an identified ULD 2.1 is moved at least partially manually. The movement is performed by an operator, who receives navigation instructions on a screen 18 as a movement command for an intended movement of the ULD 2.1. The movement instructions are determined as a function of the sorting criterion and can be output as specifically as desired. Either only the final destination can be specified, or else the precise route. The occupancy status of the subareas is taken into account for the movement commands, since the ULD 2.1 can of course only be moved into or via free subareas.

The movement commands can not only be given to a human operator, but can also be executed by a transport vehicle (AGV, forklift, etc.). The background system then selects a transport vehicle, e.g. the one situated nearby, and controls it via movement instructions of the ULD 2.1, which the transport vehicle executes. Thus it is possible for the manual processes to be included and controlled by the background system.

Since the position of the identified ULD 2.1 is continuously monitored, deviations between an intended and an actually captured movement can be detected in the background system and signaled with a message. The more detailed the movement instruction, the smaller the deviation as of which a message is signaled. If the final destination is given as the only movement instruction, only large distances from the final destination or unique movements in the opposite direction, not required because of the occupancy situation, are signaled.

Thus when transport instructions are given to the operating personnel, the capture technology is used to verify whether the correct unit is being moved as intended. If an operating error is detected, this is signaled accordingly.

In accordance with one form of embodiment, the captured position of an identified ULD 2.1 that is being looked for (e.g. because of urgent loading of the associated flight) can be displayed at any time. Thus ULDs 2 cannot get lost and the time an operator spends looking for a specific ULD 2.1 is minimized.

An additional camera image is optionally linked to the mapping of the background system or the background system can issue position instructions to an operator to easily find the ULD 2.1 being looked for.

In accordance with one form of embodiment, in the background system, which can be included in the higher-level IT transport system, a length of time spent by the identified and/or the captured but not (yet) identified transport units 2.1, 2 in the control area 4 is checked. If the length of time exceeds a predetermined value, this is signaled with a message. Thus it is possible to prevent ULDs 2.1, 2 that have been standing too long (i.e. longer than the respective predetermined value) from being forgotten, whether or not they were initially captured.

In accordance with one form of embodiment, FIG. 3b shows a display 18, which maps the control area 4′. Not only the movement commands 32, but also the intended and/or actual movement 30′ of a transport unit 2.1, 2, are displayed in the virtual image of the control area 4′.

It is expedient to adjust the size of the control area 4 and/or the capture rate and/or the number and/or sensitivity of the position capture means 8 (technically or device-related), since a larger control area 4 or a high capture rate or a high resolution is linked to a high level of computational effort. FIG. 4 shows an installation 6 having two differently designed control areas 4a, 4b. The first control area 4a with high monitoring granularity comprises the area of loading and/or unloading of ULDs 4 at loading stations 16. For precise monitoring of the loading operation, many and/or sensitive sensors 8 are required. The second control area 4b comprises a transport and storage area 4b of the installation 6. Since no loading operations and thus no loading units 26 (these are naturally smaller than their corresponding ULDs 2.1, 2) need to be monitored, a lower monitoring granularity is sufficient.

The differentiation of the control areas 4a, 4b takes place either by selection of the position capture means 4 or else purely technically by including less capture data during the capture of the second control area 4b, even if in fact a higher capture sensitivity would be possible, since more capture data is present. In this way the computational effort can be minimized without the need for a device-related adjustment.

With the inventive system and method it is always known at any capture time where which ULD 2.1 is situated in the control area 4. By determining the shape or volume of the objects 12, 2, 2.1, 26 in the capture area the quantity and size of the material 26 to be packed at a loading station 16, the ULDs 2.1 to be transported and the space 28 remaining on them is known at each capture time. When packing a ULD 2.1 a constant update is provided of the space still available on the pallet. Whether the material 26 assigned to a specific ULD 2.1 has also in fact been loaded onto this ULD 2.1 can be verified physically.

The core of the invention is the permanent position tracking of a ULD 2.1 once identified by the background system at sufficiently short capture intervals by a position capture means 8 for which inter alia lidar systems or camera systems are suitable. Thus the background system always maps the position of the captured ULD 2.1 without the need for further identifications of the ULD 2.1. Transport instructions can be issued to the operating personnel and with the help of capture technology 8 it is possible to verify whether the correct ULD 2.1 is being moved. A detected operating error is signaled accordingly. The combination of physical control and IT data management enables constantly updated information on the location of each ULD 2.1, 2 in the control area 4. It does not matter whether the ULDs 2, 2.1 are transported to another space automatically or else manually. Moreover, the capture system can monitor whether persons are in an area that is used in mixed operation. This has the advantage that automatic movements in an area in which persons are situated can be prevented.

ULDs 2.1 can also be tracked when being moved manually. The fill level of the control areas 4 is mapped without the need for further capture steps by the operating personnel. The flow of material in the control area 4 can be controlled by tracking the mapped transport units 2, 2.1. Operating errors (movement of other ULDs 2, moving the intended ULD 2.1, but to the wrong location) are prevented. Operating personnel can be assisted during sorting by the issue of movement commands. By monitoring the length of time ULDs 2, 2.1 spend in the control area 4, it is possible to detect ULDs 2, 2.1 that have not been handled for too long a time. The loss of material 2, 2.1, 26 is prevented. The status of the ULDs 2, 2.1 can be monitored (damage control, monitoring of loading/unloading).

The detection of persons in the control area allows ULDs 2 to be differentiated from personnel, and manipulations of the ULDs 2 can be detected. Access controls can be set up and automatic movement restricted by assigning occupancy prohibitions to subareas.

Linking the information from the initial capture to the continuous position capture allows transport units 2, 2.1 to be located and tracked in real time. For better visualization, a link can be made to a camera image.

If operating personnel are looking for a specific transport unit 2.1, the position can be output by the background system, if applicable with additional movement commands for the operating personnel. Thus the transport unit can be found quickly, and incorrect placements and empty runs are prevented.

The method can be combined with other systems for precise location, for example for the initial capture of the identity of the transport unit 2.1 a hand-held scanner can be marked with an RFID tag in order to determine the position of the initial capture.

In accordance with one form of embodiment, deviations of the actual movement of a transport unit 2.1 from a movement intended by the movement commands are signaled with a message.

In accordance with one form of embodiment, the background system has access to further information, e.g. flight schedules. Thus the clearance (loading and unloading operations, collection from temporary storage, movement to the airside exit) of certain ULDs 2.1 can be prioritized, the background system supports the operating personnel by displaying the next logistics tasks and providing support with decisions when assembling freight. Further information (battery level, priority of perishable goods or medicines, temperature for cold chain control) can likewise be taken into account by the background system to prioritize the work steps to be performed.

### LIST OF REFERENCE CHARACTERS

2 Transport unit
4 Control area
4a First control area, loading/unloading area
4b Second control area, storage/transport area
6 Installation
8 Position capture means, lidar sensor
12 Further object, person
14 Conveyance element
16 Loading station, workstation
18 Display
20 Message
22 Conveyance element
24 Infeed conveyor, entry device
26 General cargo, loading units
28 Free space
30 Movement (intended, actual)
32 Movement command

1-15. (canceled)

16. A method for controlling a movement of transport units with associated sorting criteria within a control area of an installation, the method comprising steps of:
a) initially capturing an identity and a time stamp of one or more transport units at a known initial position;
b) moving at least one of the transport units;
c) capturing positions of the transport units within the control area over time by using a position capture device configured to capture the positions of transport units without separate marking of the transport units;
d) continuously transmitting the captured data to a background system;
e) continuously assigning the captured positions of the transport units to the captured identity of a respective transport units by using the background system, starting from an initial position; and
f) mapping the positions of the transport units in the control area by using the background system.

17. The method according to claim 16, which further comprises:
carrying out step a) by initially capturing an identity and a time stamp of one or more transport units in connection with an entry of a transport unit into the control area;
carrying out step b) by moving the identified transport unit; and
carrying out step f) by mapping the positions of the identified transport unit.

18. The method according to claim 16, which further comprises providing the position capture device with at least one of a lidar sensor or a camera system or a light grid or an optical sensor.

19. The method according to claim 16, which further comprises capturing a shape of the identified transport unit within the control area over time by using the position capture device or another device configured to capture a shape of objects or of transport units.

20. The method according to claim 19, which further comprises using the background system to at least one of detect and signal with a message or store deviations of the captured shape of the transport units or of the identified transport unit, at different capture times.

21. The method according to claim 18, which further comprises:
at least one of loading or unloading a transport unit with one or more loading units within the control area; and
performing steps a) to f) for the one or more loading units and for a transport unit.

22. The method according to claim 16, which further comprises using the background system to check a length of time which at least one of the identified or captured transport units spends in the control area, and signaling with a message upon the length of time exceeding a predetermined value.

23. The method according to claim 16, which further comprises capturing further objects in the control area by using the position capture device or another device configured to capture the further objects or moving objects or persons, and transmitting the captured data to the background system.

24. The method according to claim 16, which further comprises using the background system to issue instructions for an intended movement of the identified transport unit, and implementing the instructions by at least one of using operating personnel or automatically.

25. The method according to claim 24, which further comprises using the background system to detect and signal deviations between the intended and actually captured movement by using a message.

26. The method according to claim 16, which further comprises dividing the control area into subareas and at least one of assigning universal or transport-unit-specific occupancy prohibitions to one or more of the subareas or displaying at least one of free or occupied subareas.

27. The method according to claim 16, which further comprises providing the installation with two or more control areas having at least one of different requirements for accuracy or frequency of capture by the position capture device.

28. The method according to claim 27, which further comprises providing the two or more control areas with at least one of a different type or number or sensitivity of the position capture device.

29. The method according to claim 16, which further comprises at least one of providing the installation with manual conveyance elements or configuring the transport units to be moved automatically.

30. The method according to claim 16, which further comprises displaying the captured position for at least one of a selected identified or captured transport unit.

31. A system for controlling a movement of transport units with associated sorting criteria in an installation, the system comprising:
a device for capturing an identity and a time stamp of one or more transport units at a known initial position;
a position capture device configured to capture positions of transport units within a control area over time without needing separate marking of the transport units;
a background system receiving the captured data, said background system configured for a continuous assignment of the captured positions of the transport units to the captured identity of a respective transport unit and for mapping the captured positions of the identified transport units;
the system configured to perform the method according to claim 16.
